(19) United States
(12) Patent Application Publication
(10) Pub. No.: US 2011/0253067 A1
(43) Pub. Date: Oct. 20, 2011

(54) PIPE FITTING

(76) Inventors: Joseph Vetter, Raleigh, NC (US); James Kevin Merrill, Raleigh, NC (US); James Punjack, Pittsburgh, PA (US); John Punjack, Pittsburgh, PA (US)

(21) Appl. No.: 12/761,871

(22) Filed: Apr. 16, 2010

(51) Int. Cl. F24H 9/20; F16L 25/00

(52) U.S. Cl. 122/14.31; 285/383

(57) ABSTRACT

A pipe fitting is connected in a conduit from a source of fluid under pressure. The pipe fitting comprises a tubular body defining an elongate interior chamber open at both an upstream end and a downstream end. The wall of the body defines a plurality of radial passages opening into the interior chamber and extending through the wall at an acute angle relative to the longitudinal axis of the body. The passages open to the atmosphere through the wall axially spaced upstream from the passage openings into the interior. Fluid flows through the body from the upstream end to the downstream end without escaping through the passages. When fluid flow is blocked downstream of the body, backflow of fluid is directed radially outwardly and angularly upstream through the passages to the atmosphere.

### BACKGROUND

This application relates generally to a pipe fitting, and more particularly to a pipe fitting for use in a discharge or drainage system from a source of fluid, such as a water heater.

A conventional residential water heater typically comprises a water tank that is electrically heated or heated using natural gas. For safety reasons, the water heater must be vented to release fluid if the temperature or pressure within the tank becomes too high. This is accomplished using a temperature or pressure relief valve that exits to the exterior of the tank. The relief valve is configured to be attached to a conventional standpipe for carrying away the discharged fluid. For example, as schematically shown in FIG. 1, a drainage system 50 comprising the standpipe is used in conjunction with the relief valve for conducting the fluid from the water heater 52 via a conduit or discharge pipe 54 to outside of a building 56. In a high temperature or high pressure situation, fluid is vented from the relief valve and flows through the discharge pipe.

A disadvantage to the arrangement described above is that the outlet of the drainage system is exposed to the environment. There are circumstances when the outlet of the discharge pipe becomes plugged by dirt or other contaminants, or the discharge pipe opening may be frozen closed. This prevents an exit path for the fluid conveyed through the discharge pipe. As a result, there is no temperature or pressure relief vent for the water heater.

The International Code Council (“ICC”) plumbing code requires that fluid discharge must be provided through an air gap in the same room as the water heater either onto the floor, into an indirect waste receptacle, or outdoors. In many applications, this requirement is met with the standpipe interposed between the relief valve and the outlet of the discharge pipe for safe release of fluid when the drainage system is blocked. In one configuration for accomplishing the required air gap, a pipe leading from the relief valve is inserted into a discharge pipe of larger diameter. For example, an end of a ¾ inch pipe leading from the relief valve may be inserted into a 1½ inch pipe leading to outside of the building. Another arrangement includes using a 1½ to 1¼ inch reducing coupling upside down and running 1¼ inch pipe to outside. Both arrangements provide an air gap that complies with ICC plumbing code requirements. However, neither provides a secure connection, including a mechanical break in continuity potentially allowing for relative movement, and both result in fluid being expelled in the interior of the building.

For the foregoing reasons, there is a need for a more secure pipe fitting for use in a discharge system form a source of fluid that meets plumbing code requirements. Ideally, the new pipe fitting will convey fluid away from the source of fluid in temperature and pressure relief situations.

### SUMMARY

A pipe fitting is provided for connection in a conduit from a source of fluid under pressure. The pipe fitting comprises a tubular body defining an elongate interior chamber open at both an upstream end and a downstream end. The wall of the body defines a plurality of radial passages opening into the interior chamber and extending through the wall at an acute angle relative to the longitudinal axis of the body. The passages open to the atmosphere through the wall such that the passage openings into the interior are axially spaced downstream from the passage openings to the atmosphere. Means are provided for connecting the ends of the body in the conduit for providing a fluid flow path through the body substantially coextensive and coaxial with the conduit. Fluid flowing through the body from the upstream end to the downstream end passes along the flow path without escaping through the passages. When fluid flow is blocked downstream of the body, backflow of fluid is directed radially outwardly and angularly upstream through the passages to the atmosphere.

A fluid discharge system is also provided, comprising a fluid heating appliance including a fluid reservoir and a valve adapted to be connected to an outlet of the appliance for selectively discharging fluid in response to temperature or pressure conditions upstream of the valve. A tubular fitting defines an elongate interior chamber having an inlet at an upstream end and an outlet at a downstream end. The upstream end of the fitting is secured to a downstream end of the valve and the downstream end of the fitting is secured to an upstream end of a discharge conduit for providing a flow path through the chamber substantially coextensive and coaxial with the discharge conduit. The wall of the fitting defines a plurality of radial passages opening into the interior chamber in fluid communication with the flow path and extending through the wall at an acute angle relative to the longitudinal axis of the fitting upstream of the flow path and opening to the atmosphere such that the openings into the flow path are downstream from the openings to the atmosphere. Fluid discharged from the valve passes through the fitting from the inlet to the outlet along the flow path without escaping through the passages. When the discharge conduit downstream form the fitting is blocked from fluid flow, backflow of fluid is directed radially outwardly and angularly upstream through the passages to the atmosphere.

### BRIEF DESCRIPTION OF THE DRAWINGS

For a more complete understanding of the pipe fitting, reference should now be had to the embodiments shown in the accompanying drawings and described below. In the drawings:

FIG. 1 is schematic view of a building including a water heater with a discharge pipe to the exterior of the building.

FIG. 2 is a perspective view of a pipe fitting for use in the discharge pipe as shown in FIG. 1.

FIG. 3 is an elevation view of the pipe fitting as shown in FIG. 2.

FIG. 4 is a top end view of the pipe fitting as shown in FIG. 3.

FIG. 5 is a bottom end view of the pipe fitting as shown in FIG. 3.

FIG. 6 is perspective view of the pipe fitting as shown in FIG. 2 connected in a discharge system to a pressure relief valve in fluid communication with a water heater.

FIG. 7 is a longitudinal cross-section view of the connected pipe as shown in FIG. 6.

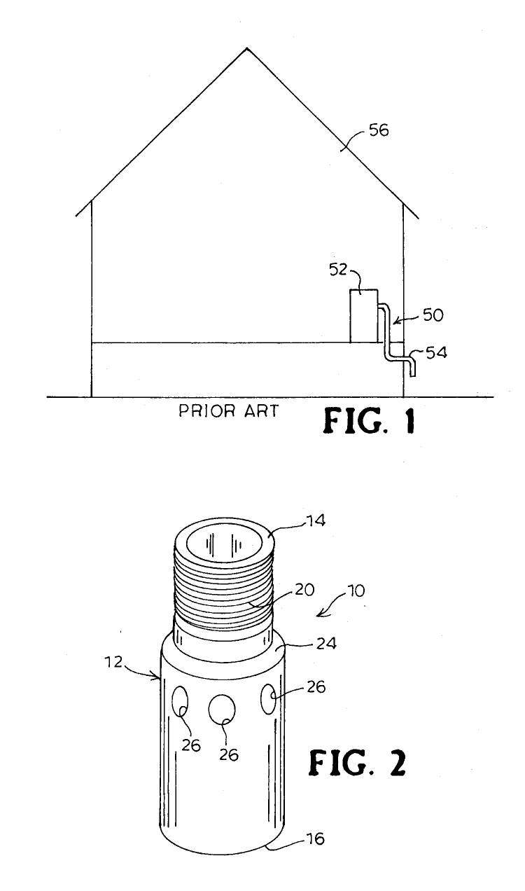

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

It is understood that, although a pipe fitting will be described in detail herein with reference to an exemplary embodiment of the pipe fitting for use with a water heater, the pipe fitting may be applied to, and find utility in, other pressure and temperature relief applications from a fluid source. Pressure relief valves for expelling fluid are used in a wide variety of devices and appliances such as, for example, water conditioners, water filters, washing machines, ice making machines, commercial dishwashers and the like, which operate with fluid under legated temperature or pressure conditions. Thus, the pipe fitting has general applicability in any configuration wherein improvements in fluid discharge are desired.

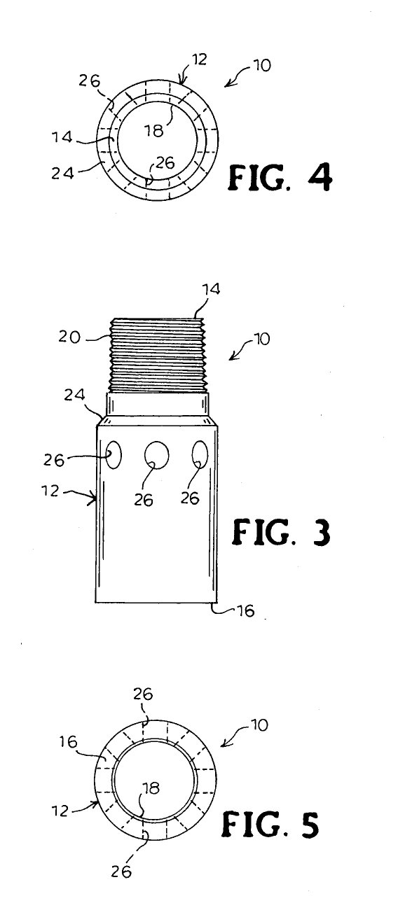

Referring now to the drawings, wherein like reference numerals designate corresponding or similar elements throughout the several views, an embodiment of a pipe fitting is shown in FIGS. 2-5 for connection in a discharge pipe from a source of fluid, and generally designated at 10. The pipe fitting 10 comprises a cylindrical tubular body 12 having a longitudinal axis. The pipe fitting 10 is preferably formed from metal, but can be made of plastic, particularly where it may be necessary to bond it to plastic drain pipe.

The body 12 has an upstream end 14 and a downstream end 16 and the interior of the body defines an axial bore 18 for fluid flow. The upstream end 14 is provided with a male externally threaded portion 20 and the downstream end 16 is provided with a female internally threaded portion 22. As described in more detail below, the male threads 20 are adapted to threadably connect to the female threads of a conventional union fitting carried by a downstream portion of a discharge pipe, and the internally threaded downstream end of the body is adapted to threadably connect to the male threads provided on the upstream portion of the discharge pipe. In another embodiment, both ends 14, 16 of the body 12 of the pipe fitting 10 may be similarly threaded. In addition, the body 12 may have suitable wrench flats (not shown) disposed about the circumference of the body to receive a wrench to rotate the pipe fitting 10, or resist rotation of the pipe fitting, as needed for enabling tightening and removal of screwed couplings or pipe fittings to either end 14, 16 of the body 12.

Although the embodiments of the pipe fitting 10 shown in the drawings are configured for threaded connection with adjacent portions of a discharge pipe having threaded fittings, the pipe fitting 10 may also be adapted for connection to unthreaded pipe couplings. For example, for discharge pipes comprising plastic pipe, conventional connecting plastic sleeves (not shown), smeared or coated internally with adhesive, can be slipped over the ends of the body 12 and the adjacent plastic discharge pipe. Another means for coupling the pipe fitting 10 in a discharge pipe may be particularly adapted for flexible tubing. In this arrangement, the upstream end 14 of the body 12 is attached to an internally threaded cylindrical tubing adapter (not shown) using an appropriate fitting. As is known in the art, an unthreaded exterior portion of the adapter is characterized by bayonet type ridges for retaining such portion within the interior of the upstream end 14 of the body 12. A conventional hose clamp (not shown) is employed to prevent separation of the components. A similar arrangement is used to secure connection of the downstream end 16 of the body 12 to a similar tubing adapter, except that the adapter is characterized by male threads for threadably mounting the adapter to the female threads 22 of the downstream end 16 of the body 12. It is understood that the embodiments of the end couplings or end fittings described herein for connecting the pipe fitting 10 in a discharge pipe are merely exemplary. The pipe fitting 10 may comprise various end coupling or fitting arrangements known to those skilled in the art whereby the pipe fitting 10 can be readily connected by threaded attachment, by adhesive connection for plastic pipe, by compression fittings for flexible tubing, and the like.

Intermediate the ends of the body 12 is an exterior annular shoulder 24 which projects angularly outwardly in the downstream direction. A plurality of circumferentially disposed, radially directed ports 26 are formed in the body 12 of the pipe fitting 10 downstream of the shoulder 24. The ports 24 open into the axial bore 18 and extend to the exterior of the body 12 for providing fluid communication between the bore 18 and the atmosphere. In one embodiment, eight ports 26 are equally spaced about 45° apart around the periphery of the pipe fitting 10. The walls of the body 12 defining the ports 26 are angled in the downstream direction defining an acute angle with the upstream longitudinal axis of the body 12. The angled ports minimize escape via the ports 26 of fluid normally flowing downstream through the bore 18, taking advantage of the kinetic energy of the fluid flow. As described below, the ports 26 function when the discharge pipe is blocked to provide backflow passages for discharging fluid in a plurality of centrifugal radial directions. In one embodiment, the sum of the cross-sectional area of all of the ports is substantially equal to the cross-sectional area of the bore 18.

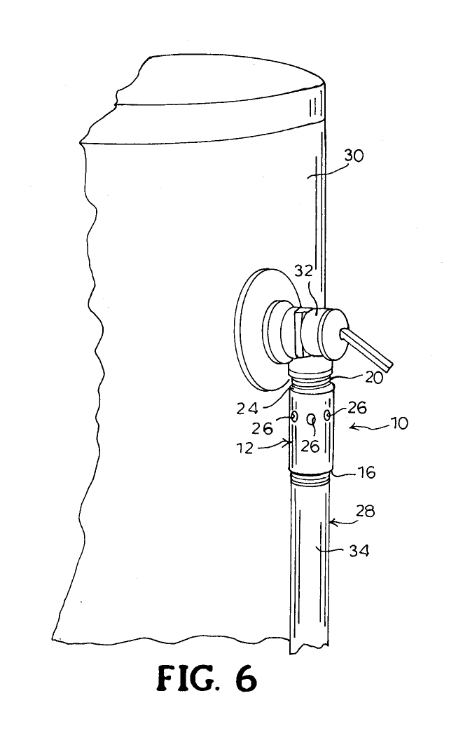

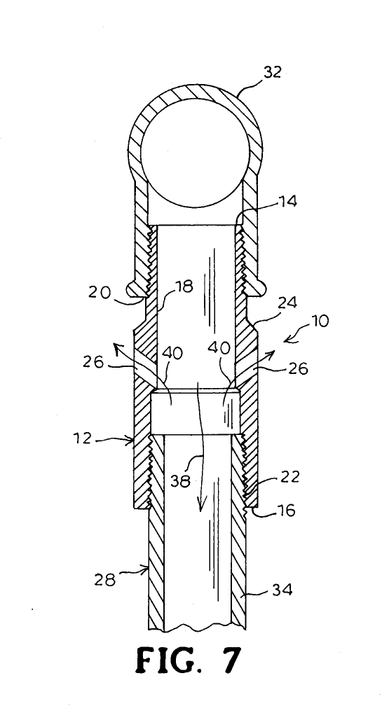

In one embodiment, the pipe fitting 10 is adapted for mounting directly into a discharge system of a conventional water heater 30. As shown in FIGS. 6 and 7, the male threads 20 of the upstream end 14 of the body 12 are threadably connected to a female threaded downstream opening of a relief valve 32 for establishing a threaded connection between the pipe fitting 10 and the relief valve 32. The internally threaded downstream end 16 of the body 12 is threadably connected to male threads provided on the upstream end of the standpipe 34 of a discharge pipe. Teflon tape 36 may be disposed on the male threads 20 of the body 12 to provide a fluid tight connection. When connected, a continuous axial opening (FIG. 7) is formed from the relief valve 32 and through the bore 18 of the body 12 of the pipe fitting 10. The axial opening has a diameter substantially the same as the internal diameter of the standpipe so as to provide a smooth flow path. Moreover, the outside diameter of the discharge pipe is also the same.

In the application shown in the FIGs., the pipe fitting 10 is disposed vertically. It is understood that the pipe fitting 10 is also operable in other orientations, including horizontal and various angular orientations between vertical and horizontal. The vertical orientation is a typical application, but an angular mounting of the pipe fitting 10 may be preferred for applications involving space constraints.

In operation, the relief valve 32 is adapted to open upon attainment of a predetermined pressure or temperature within the interior of the water heater 30. When the relief valve 32 is open, fluid, in this case hot water or steam, is permitted to flow through the pipe fitting 10 in the downstream direction and into the standpipe 34 as illustrated by an arrow 38 in FIG. 7. If the discharge pipe is not blocked, the pipe fitting 10 provides a smooth flow path for the fluid through the pipe fitting. Because the walls of the body 12 defining the ports 26 are angled downstream, fluid does not exit the pipe fitting 10 through the ports 26 under normal fluid discharge conditions. Thus, high pressure and high temperature in the water heater 30 are avoided.

Should the discharge pipe be clogged such that fluid exiting the water heater 30 through the relief valve 32 cannot advance, the fluid will back up in an upstream direction into the pipe fitting 10. The backed up fluid under pressure will escape the pipe fitting 10 through the ports 26. As illustrated by the arrows 40 in FIG. 7, this condition results in an angularly outward discharge of fluid through the ports 26 to the atmosphere.

Thus, there has been described embodiments for a pipe fitting 10 which can be used in a fluid discharge system in conjunction with a relief valve 32 for protection against high pressure and temperature conditions in which fluid under pressure must be vented to the atmosphere. The pipe fitting 10 is operable to prevent fluid from escaping through the ports 26 during normal fluid discharge conditions. The pipe fitting 10 is configured for easy attachment to conventional pipe, and can readily accommodate various conventional plastic, copper, brass or steel adapter fittings typically provided as off-the-shelf items for installing the fluid discharge system. The embodiments of the pipe fitting 10 described herein provide a rigid discharge pipe connection that ensures a safe and professional installation. Users are provided with a necessary plumbing connection to satisfy plumbing codes, and which will obviate the practice of the installer creating a custom on-site connection with air gap that is less reliable. The pipe fitting 10 is readily adaptable for use or re-use in retrofit situations in order to bring existing discharge pipes, such as for water heaters, up to code.

Although the present invention has been shown and described in considerable detail with respect to only a particular exemplary embodiments thereof, it should be understood by those skilled in the art that we do not intend to limit the invention to the embodiment since various modifications, omissions and additions may be made to the disclosed embodiment without materially departing from the novel teachings and advantages of the invention, particularly in light of the foregoing teachings. For example, the pipe fitting may be used in any water heating appliance or other source of fluid under elevated pressure or temperature conditions. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A pipe fitting for connection in a conduit from a source of fluid under pressure, the pipe fitting comprising:
a tubular body defining an elongate interior chamber open at both an upstream end and a downstream end, the wall of the body defining a plurality of radial passages opening into the interior chamber and extending through the wall at an acute angle relative to the longitudinal axis of the body and opening to the atmosphere such that the passage openings into the interior chamber are axially spaced downstream from the passage openings to the atmosphere; and
means for connecting the ends of the body in the conduit for providing a fluid flow path through the body substantially coextensive and coaxial with the conduit,
wherein fluid flowing through the body from the upstream end to the downstream end passes along the flow path without escaping through the passages, and wherein any backflow of fluid is directed radially outwardly and angularly upstream through the passages to the atmosphere when fluid flow is blocked downstream of the body.

2. A pipe fitting as recited in claim 1, wherein the connecting means is selected from soldering, a hose barb adapter and hose clamp, and the like.

3. A fluid discharge system, comprising:
a fluid heating appliance including a fluid reservoir;
a valve adapted to be connected to an outlet of the appliance for selectively discharging fluid in response to temperature or pressure conditions upstream of the valve;
a discharge conduit having an upstream end and a downstream outlet end; and
a tubular fitting defining an elongate interior chamber having an inlet at an upstream end and an outlet at a downstream end, the upstream end of the fitting secured to a downstream end of the valve and the downstream end of the fitting secured to an upstream end of the conduit for providing a flow path through the chamber substantially coextensive and coaxial with the conduit, the wall of the fitting defining a plurality of radial passages opening into the interior chamber in fluid communication with the flow path and extending through the wall at an acute angle relative to the longitudinal axis of the fitting upstream of the flow path and opening to the atmosphere such that the openings into the flow path are downstream from the openings to the atmosphere,
wherein fluid discharged from the valve passes through the chamber from the inlet to the outlet along the flow path without escaping through the passages, and wherein any backflow of the fluid is directed radially outwardly and angularly upstream through the passages to the atmosphere when the discharge line is blocked from fluid flow downstream of the fitting.

4. The fluid discharge system as recited in claim 3, wherein the angle is between about 90 degrees and about 0 degrees.

5. The fluid discharge system as recited in claim 3, wherein the fitting is threadably connected to the upstream end of the discharge conduit.

6. The fluid discharge system as recited in claim 3, wherein the fluid is water heated to near boiling point.

7. The fluid discharge system as recited in claim 3, the cross-sectional area of the flow path is substantially equal to the sum of the total of the cross-sectional area of the passages.

8. The fluid discharge system as recited in claim 3, wherein the fitting further comprises wrench flats to rotate the fitting or resist rotation of the fitting.
